(19) United States
(12) Patent Application Publication
(10) Pub. No.: US 2013/0060840 A1
(43) Pub. Date: Mar. 7, 2013

(54) SYSTEM AND METHOD FOR OPTIMIZING THE DELIVERY OF A STREAMED APPLICATION

(71) Applicants: Michael A. Avina, Tampa, FL (US); Timothy M. Roberts, Tampa, FL (US)

(72) Inventors: Michael A. Avina, Tampa, FL (US); Timothy M. Roberts, Tampa, FL (US)

(73) Assignee: SAVTIRA CORPORATION, INC., Tampa, FL (US)

(21) Appl. No.: 13/402,489

(22) Filed: Feb. 22, 2012

Related U.S. Application Data
(60) Provisional application No. 61/445,051, filed on Feb. 22, 2011.

(51) Int. Cl. G06F 15/16; G06F 17/30

(52) U.S. Cl. 709/203

(57) ABSTRACT

The disclosed embodiments relate to a method, an apparatus, and computer-readable medium storing computer-readable instructions for optimizing the delivery of a streamed application.

### RELATED APPLICATION DATA

This application claims priority to U.S. Provisional Application No. 61/445,051, filed Feb. 22, 2011, which is hereby incorporated by reference in its entirety.

### BACKGROUND

The advent of cloud-based entertainment has made the delivery of virtual machines and remotely streamed content a trivial process for content providers. Users who access virtual machines and remotely streamed content now do so via a multitude of display and input devices such as computers, netbooks, mobile handsets, televisions, etc. Each new device provides a new challenge for cloud-based entertainment service providers to tailor their content delivery to meet the limitations and functionality of each new device. As a result, existing cloud-based entertainment platforms tend to limit the delivery and operation of their platform to specific classes of consumer devices such as mobile handsets or netbooks.

Generally, “cloud-based entertainment” is typically used to refer to the delivery of media, applications and content from a distributed server and network environment. In this instance, delivery may refer to the transmission of a file or set of files, or the transmission of a stream of video representing the real-time state of an application, movie, book, or other source being sent from a machine operating within such a distributed environment.

### SUMMARY

The disclosed embodiment relates to a method for optimizing the delivery of a streamed application. An exemplary method comprises electronically storing, by a content storage system, digital content, retaining, by a database, the state of any electronic content being accessed, where the state comprises any number of digital properties related to a device accessing a particular type of media, and the type of device being used to access such content, rendering, by one or more video or audio encoders, the delivery of content to a wide variety of devices, and providing, by a user interface, the user with the capability to access and modify the state of previously accessed media.

The disclosed embodiment further relates to an apparatus for optimizing the delivery of a streamed application. An exemplary apparatus comprises one or more processors, and one or more memories operatively coupled to at least one of the one or more processors and containing instructions that, when executed by at least one of the one or more processors, cause at least one of the one or more processors to electronically store digital content, retain the state of any electronic content being accessed, where the state comprises any number of digital properties related to a device accessing a particular type of media, and the type of device being used to access such content, render the delivery of content to a wide variety of devices, and provide the user with the capability to access and modify the state of previously accessed media.

In addition, the disclosed embodiment relates to at least one non-transitory computer-readable medium storing computer-readable instructions that, when executed by one or more computing devices, optimize the delivery of a streamed application. Exemplary instructions can cause at least one of the one or more computing devices to electronically store digital content, retain the state of any electronic content being accessed, where the state comprises any number of digital properties related to a device accessing a particular type of media, and the type of device being used to access such content, render the delivery of content to a wide variety of devices, and provide the user with the capability to access and modify the state of previously accessed media.

According to the disclosed embodiment, the capability to access and modify the state of previously accessed media can include, for example, resuming the playing of media, halting the playing of media, and other relevant actions.

### BRIEF DESCRIPTION OF THE DRAWINGS

FIG. 1 illustrates an exemplary embodiment in which a user accesses content being stored or operated within a cloud of servers or virtual machines with a first device.

FIG. 2 illustrates an exemplary display screen presented to a user when the user accesses their personal library of content.

FIG. 3 illustrates an exemplary computing device according to the disclosed embodiment.

### DETAILED DESCRIPTION

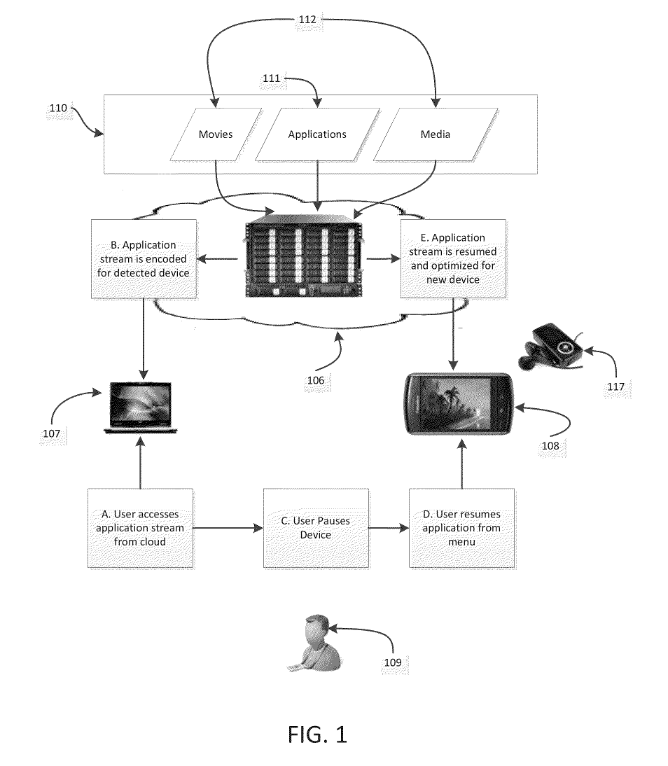

Referring to the diagrams, FIG. 1 represents an embodiment where a user 109 accesses content 110 being stored or operated within a cloud of servers or virtual machines 106 with a first device 107. The user 109 then pauses the stream of the first device 107. The cloud maintaining the content 110 then proceeds to store the state of the content at which time the content was paused.

In instances where the content 110 is an application 111, information relating to the type of device performing the pause action such as screen dimension, cursor position, mouse-click state, keypress state, screen resolution, and other states within the virtual machine are then stored within the cloud 106.

In instances where the content 110 is a media 112, information relating to the media's play position, transcoding bitrate, volume settings, language preferences, or other relevant setting information such as, in the instance of a song, the position within a playlist or a social-network option to share the status of playing a particular song with friends will be retained and stored within the cloud 106.

The user 109 then chooses another device 108 having a display and input device and accesses their personal library of content 110 within the cloud 106.

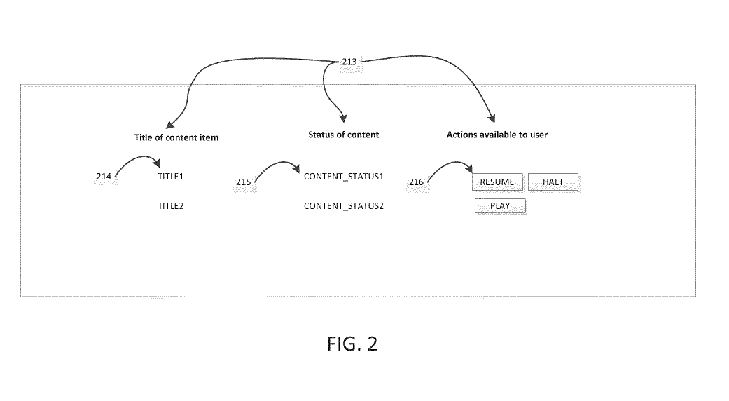

FIG. 2 represents a display screen 213 presented to the user 109 when the user accesses their personal library of content 110. The display screen provides the user 109 with the title of each content item 214, a description of the status of each content item 215, and a series of buttons 216 providing the user with the option to perform actions relevant to the status of the content item 215.

When the user 109 selects one of the buttons 216 indicating that the user 109 wishes to resume the content 110, the cloud then proceeds to access the previous state of the content 109 from the cloud 106. The content 110 is then optimized for delivery on the new device 108.

For instance, if the user 109 is playing a movie or stream of media 112 on a device 107, and then performed a pause action and proceeds to resume the movie 112 on a separate device 108, the content will be encoded in order to fit within the dimensions of the new display screen on the device 107. In addition, settings such as volume levels, sound preferences, language preferences, and quality preferences will be restored on the device 107. The media 112 will be delivered to most closely match the capabilities known to exist on the device 107.

In an instance when the media 112 is resumed on a device 217 not having a visual display whereas the initial device 107 provided such a display, the media 112 will be encoded with only an audio stream. For example, the user 109 may have been watching a sports movie on a display device 107 and then wish to listen to the stream on a device lacking a visual display but only having an audio capability 217. The disclosed embodiment provides a significant advantage to the user 109 in terms of bandwidth conservation and an experience that is most suited to the preferred device at any given moment.

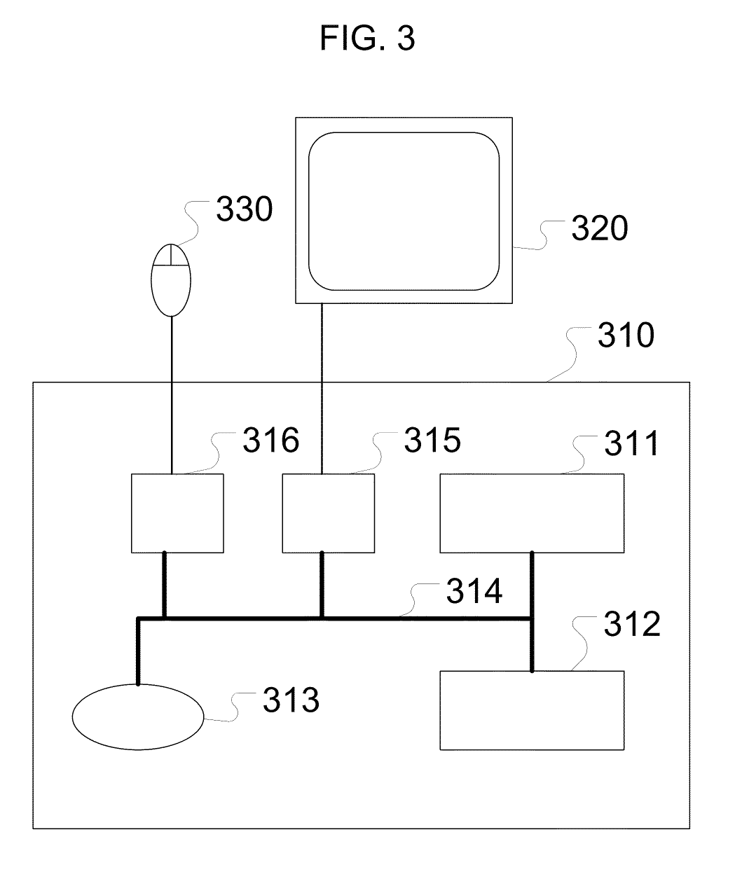

The embodiments described herein may be implemented with any suitable hardware and/or software configuration, including, for example, modules executed on computing devices such as computing device 310 of FIG. 3. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 310 has one or more processing device 311 designed to process instructions, for example computer readable instructions (i.e., code) stored on a storage device 313. By processing instructions, processing device 311 may perform the steps set forth in the methods described herein. Storage device 313 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 310 additionally has memory 312, an input controller 316, and an output controller 315. A bus 314 operatively couples components of computing device 310, including processor 311, memory 312, storage device 313, input controller 316, output controller 315, and any other devices (e.g., network controllers, sound controllers, etc.), Output controller 315 may be operatively coupled (e.g., via a wired or wireless connection) to a display device 320 (e.g., a monitor, television, mobile device screen, touch-display, etc.) In such a fashion that output controller 315 can transform the display on display device 320 (e.g., in response to modules executed). Input controller 316 may be operatively coupled (e.g., via a wired or wireless connection) to input device 330 (e.g., mouse, keyboard, touch-pad, scroll-ball, touch-display, etc.) In such a fashion that input can be received from a user (e.g., a user may input with an input device 330 a dig ticket).

Of course, FIG. 3 illustrates computing device 310, display device 320, and input device 330 as separate devices for ease of identification only. Computing device 310, display device 320, and input device 330 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 310 may be one or more servers, for example a farm of networked servers, a clustered server environment, or a cloud network of computing devices.

While systems and methods are described herein by way of example and embodiments, those skilled in the art recognize that disclosed systems and methods are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A method for optimizing the delivery of a streamed application, the method comprising:
electronically storing, by a content storage system, digital content;
retaining, by a database, the state of any electronic content being accessed, where the state comprises any number of digital properties related to a device accessing a particular type of media, and the type of device being used to access such content;
rendering, by one or more video or audio encoders, the delivery of content to a wide variety of devices; and
providing, by a user interface, the user with the capability to access and modify the state of previously accessed media.

2. An apparatus for optimizing the delivery of a streamed application, the apparatus comprising:
one or more processors; and
one or more memories operatively coupled to at least one of the one or more processors and containing instructions that, when executed by at least one of the one or more processors, cause at least one of the one or more processors to:
electronically store digital content;
retain the state of any electronic content being accessed, where the state comprises any number of digital properties related to a device accessing a particular type of media, and the type of device being used to access such content;
render the delivery of content to a wide variety of devices; and
provide the user with the capability to access and modify the state of previously accessed media.

3. At least one non-transitory computer-readable medium storing computer-readable instructions that, when executed by one or more computing devices, optimize the delivery of a streamed application, the instructions causing at least one of the one or more computing devices to:
electronically store digital content;
retain the state of any electronic content being accessed, where the state comprises any number of digital properties related to a device accessing a particular type of media, and the type of device being used to access such content;
render the delivery of content to a wide variety of devices; and
provide the user with the capability to access and modify the state of previously accessed media.
